(19) United States
(12) Patent Application Publication
(10) Pub. No.: US 2016/0286824 A1
(43) Pub. Date: Oct. 6, 2016

(54) Method and Apparatus for Crimping and Cutting Pouched Dough Products

(71) Applicant: General Mills, Inc., Minneapolis, MN (US)

(72) Inventors: Ralph A Stenvik, Plymouth, MN (US); Derek Jones, Minneapolis, MN (US)

(73) Assignee: General Mills, Inc., Minneapolis, MN (US)

(21) Appl. No.: 14/673,009

(22) Filed: Mar. 30, 2015

(51) Int. Cl. A21C 11/10; A21C 11/00; A21D 6/00; A21C 11/16

(52) U.S. Cl. CPC A21C 11/10; A21C 11/16; A21C 11/00; A21D 6/00

(57) ABSTRACT

A crimping and cutting apparatus includes a movable frame supported on a fixed frame positioned over a conveyor carrying various rows of extruded dough products. A drive unit is provided to both a) oscillate the movable frame in the first axial direction relative to the fixed frame and b) cyclically shift a crimping element in the second axial direction wherein, during a portion of operation, the crimping element is caused to engage the conveyor to crimp and cut the dough moving along the conveyor into individual dough products while the movable frame simultaneously shifts in the first axial direction in unison with the dough on the conveyor. The crimping element is specifically caused to remain in engagement with the conveyor for a dwell time while shifting in unison with the dough for a predetermined distance prior to being vertically repositioned above the dough.

### FIELD OF THE INVENTION

The invention generally pertains to the art of food making and, more particularly, to a method and apparatus for crimping and cutting pouched dough products.

### BACKGROUND OF THE INVENTION

It is known in the food art to form dough products, such as various pastries, with internal pouches containing filling material. These types of food products are typically manufactured in one of two ways. The first form includes at least filling, folding and cutting operations. In general, a filling material is applied to sections of dough sheets, the sections are cut and folded onto themselves, and then the folded sections are crimped along exposed edges portions to form individual pouched dough products. In an alternative form, the dough sections are filled after the folding operation, with a final crimping operation being performed to seal an opening to the pouch. Another known manufacturing form includes co-extruding an outer dough material with an internal filling material. Although a corresponding folding operation is avoided, in a fashion similar to that described above, this production arrangement employs a similar crimping operation, followed by a cutting operation, in forming the final products.

In the food industry, it is known to utilize a guillotine for cross-cutting purposes. In connection with a dough product which also needs to be crimped, successive crimping and cutting units are often arranged along a production line to carry out these operations. However, it is possible to employ a combination crimping and cutting element such that a crimping element which is shifted vertically to crimp peripheral portions of a food product also includes a sharpened edge, thereby simultaneously performing the cutting operation in the fashion of a guillotine. In either case, at least in the mass production of such food products, these crimping and cutting arrangements can present certain manufacturing problems. In particular, it is highly desirable to not only maintain the dough product moving in a continuous production operation, but also to employ a reasonably high conveyor speed for the product. However, since the guillotine acting arrangement only shifts vertically, even with an increase in the vertical travel speed of the guillotine unit, design practicalities mandate that the horizontal travel speed of the product be lowered or, at a minimum, the thickness of the product reduced. Otherwise, issues such as bunching, poor crimping and incomplete cutting of the product can arise.

With the above in mind, it is desired to provide a method and apparatus for crimping and cutting dough products wherein both the crimping and the cutting operations are effectively performed in the making of pouched dough products in a high speed manufacturing setting.

### SUMMARY OF THE INVENTION

The present invention is concerned with crimping and cutting dough in connection with the making of various food products including filling material. In particular, a conveyor is configured to direct dough in a first axial direction relative to a fixed frame while a movable frame mounted above the conveyor is movable in the first axial direction relative to both the conveyor and the fixed frame. A crimping element is mounted on the movable frame for movement in a second axial towards and away from the conveyor, with the second axial direction being substantially transverse to the first axial direction. At least one drive unit is provided to both a) oscillate the movable frame in the first axial direction relative to the fixed frame and b) cyclically shift the crimping element in the second axial direction. During a portion of operation, the crimping element is caused to engage the conveyor to crimp and cut the dough moving along the conveyor into at least one individual dough product while the movable frame simultaneously shifts in the first axial direction in unison with the dough on the conveyor. The crimping element is specifically caused to remain in engagement with the conveyor for a dwell time while also shifting in the first axial direction in unison with the dough for a predetermined distance prior to shifting in the second axial direction to a position vertically spaced from the dough.

In accordance with a preferred embodiment of the invention, this operation is performed by employing a cam element mounted on one of the fixed and movable frames and connected to the at least one drive unit, as well as a cam follower rotatably mounted on another of the fixed and movable frames. The cam element includes a peripheral surface biased into engagement with the cam follower and the shape of this peripheral surface establishes a cam profile resulting in oscillation of the movable frame during operation of the at least one drive unit.

With this arrangement, the cam profile is not only configured to cause oscillation of the movable frame, but also provides the dwell time during which the crimping element stays in engagement with the conveyor while the movable frame shifts in unison with the conveyor. Additional objects, features and advantages of the invention will become more readily apparent from the following description of preferred embodiments of the invention when taken in conjunction with the drawings wherein like reference numerals refer to corresponding parts in the several views.

### BRIEF DESCRIPTION OF THE DRAWINGS

FIG. 1 is a perspective view of a portion of a manufacturing line for dough products with filling material employing the dough crimping and cutting apparatus constructed in accordance with the invention.

FIG. 2 is a perspective view of the crimping and cutting apparatus of FIG. 1.

FIG. 3 is an elevational side view of the crimping and cutting apparatus.

### DETAILED DESCRIPTION OF THE INVENTION

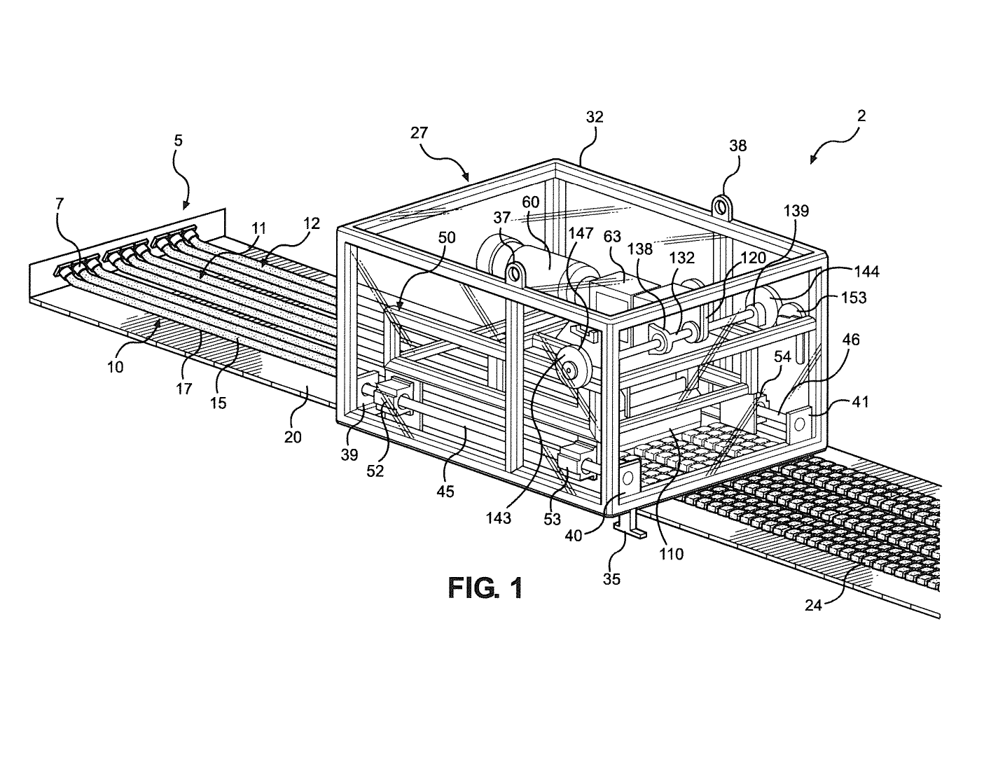

In FIG. 1, an assembly 2 is shown to include an extruder 5 having a plurality of spaced nozzles 7 establishing various rows, which are shown to be arranged in sets 10-12, of extruded, elongated product 15. Product 15 takes the form of an outer dough 17, particularly raw dough, with an internal filling (not shown), with the product 15 being deposited onto a conveyor 20. Downstream of extruder 5, each elongated product 15 is divided into a series of individual food products 24, such a filled cookies. The present invention is particularly directed to the use of a crimping and cutting apparatus 27 for converting extruded, elongated product 15 into the individual food product 24.

With reference to each of FIGS. 1-3, crimping and cutting apparatus 27 includes an outer frame 32 which extends across and straddles conveyor 20. More specifically, outer frame 32 is raised above conveyor 20 through the use of leg supports, two of which are indicated at 35 and 36. In addition, outer frame 32 is also provided with lift rings 37 and 38 which establishes crimping and cutting apparatus 27 as a modular assembly which can be readily lifted and positioned, such as in connection with retrofitting assembly 2 with crimping and cutting apparatus 27. Outer frame 32 is also provided with a plurality of lower corner brackets 39-42. Furthermore, extending between and fixed between pairs 39, 40 and 41, 42 of the corner brackets 39-42 are rails 45 and 46.

Slidably supported on rails 45 and 46 is an inner frame 50. More specifically, inner frame 50 has fixedly attached, on opposing side portions (not separately labeled), fore and aft-spaced sleeves 52-55, with sleeves 52 and 53 supporting inner frame 50 on rail 45 and sleeves 53 and 54 supporting inner frame 50 on rail 46 for sliding movement in a longitudinal or first axial direction. Inner frame 50 also has mounted thereto a motor 60 and a transfer housing 63 from which projects a transversely extending output shaft 66. In the embodiment shown, the drive on each side of transfer housing 63, which in one embodiment is a gear drive housing, is symmetrical. Therefore, a detailed description of one side will be provided and it should be understood that the opposing side is correspondingly constructed.

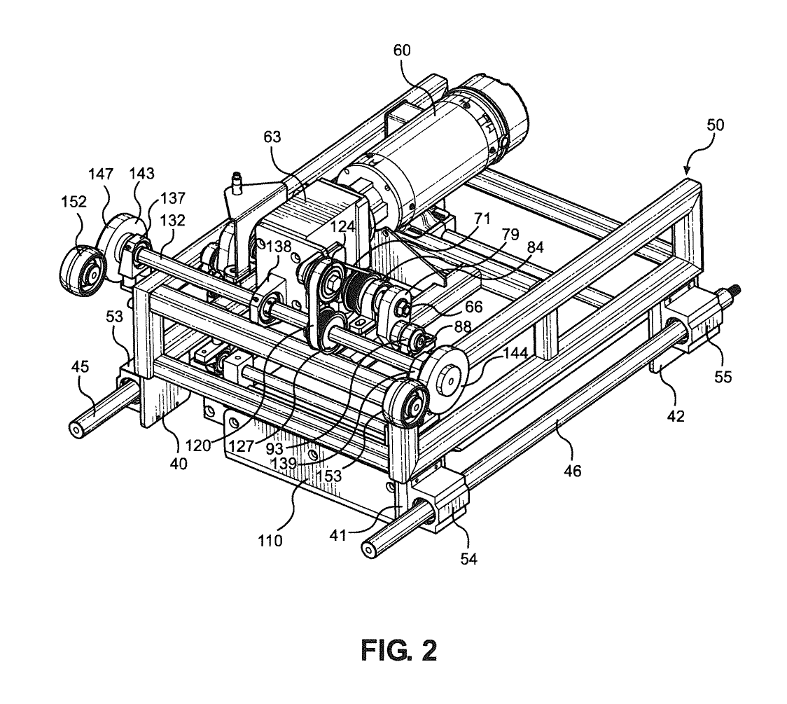

As perhaps best shown in FIG. 2, mounted for co-rotation with output shaft 66 is a drive pulley 71. Laterally outward of drive pulley 71, output shaft 66 is supported by a bearing journal 79. Beyond journal 79 is a crank arm 84 having a first end portion 85 keyed to output shaft 66 and a second end portion 86. Provided on second end portion 86 is a stub shaft 88 upon which is provided a trunnion 93 attached to a plate 95. Plate 95 has extending therefrom a shaft 96 having a threaded portion 97. In a similar manner, there is provided another plate 101 attached to a shaft 102 having a threaded portion 103. Threaded portions 97 and 103 are interconnected by a turnbuckle 107 which enables vertical adjustment of a combination, guillotine-type crimper/cutter 110. Plate 101 is pivotally attached to crimper/cutter 110 so as to rotate about a shaft 112. Crimper/cutter 110 is sandwiched for vertical movement between guides 115 and 116 attached to inner frame 50.

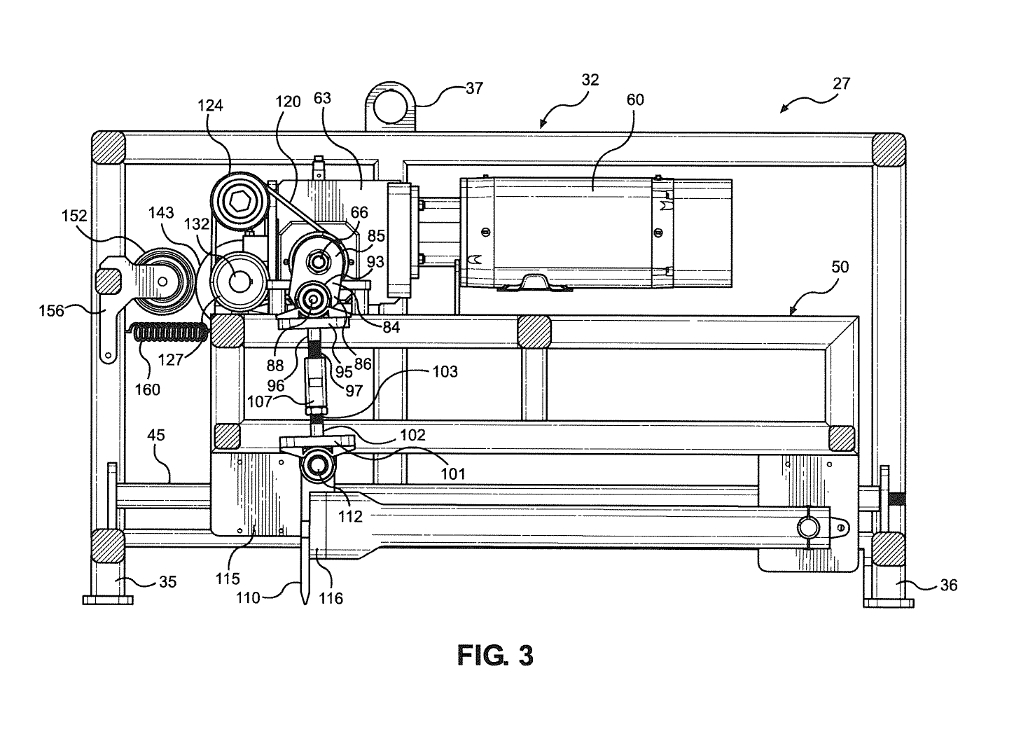

Extending around drive pulley 71 is a drive belt 120. Drive belt 120 also extends about an idler pulley 124 rotatably supported by inner frame 50 and a driven pulley 127 fixed to a transverse shaft 132. Shaft 132 is rotatably supported by various spaced journals 137-139. Also fixed to transverse shaft 132 is a pair of cam elements 143 and 144. Each cam element 143, 144 includes a peripheral surface 147 establishing a cam profile, and each cam element 143, 144 is engaged with a respective cam follower 152, 153 connected to outer frame 32 through a respective bracket 156. Cam elements 143 and 144 are maintained in contact with cam followers 152 and 153 by at least one spring 160 (see FIG. 3) extending between inner frame 50 and outer frame 32.

With this arrangement, products 15 are extruded from nozzles 7 onto moving conveyor 20 and reach the crimping and cutting apparatus 27, with motor 60 driving output shaft 66 through transfer housing 63. Rotation of output shaft 66 causes the simultaneous rotation of cam elements 143 and 144 through drive pulley 71, belt 120 and driven pulley 127, as well as crank arms 84. With the rotation of cam elements 143 and 144, inner frame 50 is oscillated back and forth based on the cam profile and the biasing of spring 160. At the same time, crimper/cutter 110 is caused to shift vertically from above conveyor 20 into engagement with conveyor 20. In accordance with the invention, crimper/cutter 110 is specifically caused to remain in engagement with conveyor 20 for a dwell time, while also shifting in the first axial or longitudinal direction in unison with the dough product 15 for a predetermined distance prior to shifting in a second axial direction to a position vertically spaced from the individual food products 24. This operation, which in accordance with the preferred embodiment of the invention is controlled based on the cam profile having a substantial portion including a constant radius of curvature, provides for enhanced crimping and assures that the food products 24 are fully severed. More specifically, this arrangement provides for a slow crimp, which not only establishes an efficient and enhanced seal but also a clean cut. The use of crimping advantageously provides for encapsulation of the filling material, as opposed to if a wire cut was utilized which would leave the products with open ends. Although various crimper/cutter arrangements can be employed in connection with the invention, in one preferred embodiment, crimper/cutter 110 is constituted by a blade having sides angled in the order of 30 degrees from a rounded, blunt edge. In addition, apparatus 27 is configured to make in the order of 40-60 cuts per minute, resulting in individual food products 24 which are less than 2 inches long, with one particular embodiment providing for products in the order of 1.75 inches long, 1.5 inches high and 2 inches wide. Furthermore, in addition to the overall structural configuration of the apparatus, the outer food material, as well as the filling, can greatly vary. For instance, the filling could include marshmallow, fruits, chocolate or various other edible materials. In any case, various changes and/or modifications can be made without departing from the spirit of the invention.

I/We claim:

1. A method of crimping and cutting dough products comprising:
directing dough in a first axial direction along a conveyor which moves relative to a fixed frame; and
operating at least one drive unit to cause a) oscillation of a movable frame positioned above the conveyor in the first axial direction relative to each of the fixed frame and the conveyor and b) cyclic movement of a crimping element, mounted on the movable frame, in a second axial direction towards and away from the conveyor wherein, during an operation cycle, the crimping element is caused to:
a) shift in the first axial direction relative to and above the dough;
b) shift in the second axial direction to engage the conveyor and crimp the dough to establish an individual dough piece;
c) remain in engagement with the conveyor for a dwell time while also shifting in the first axial direction in unison with the dough for a predetermined distance; and
d) shift in the second axial direction to a position vertically spaced from the dough.

2. The method of claim 1, wherein operating the at least one drive unit rotates a cam element mounted on the movable frame, with the cam element being in engagement with a cam follower rotatably mounted on the fixed frame, to oscillate the movable frame.

3. The method of claim 2, further comprising: biasing the movable frame in the second axial direction such that the cam element is in constant engagement with the cam follower.

4. The method of claim 2, wherein the cam element includes a cam profile configured to cause oscillation of the movable frame while providing the dwell time during which the crimping element stays in engagement with the conveyor and the movable frame shifts in unison with the conveyor.

5. The method of claim 1, wherein operating the at least one drive unit rotates a crank arm mounted on the movable frame, with the crank arm driving the crimping element for linear movement in the second axial direction.

6. The method of claim 1, wherein operation of the at least one drive unit causes the crimping element to cycle between 40-60 times per minute.

7. The method of claim 1, further comprising:
extruding the dough onto the conveyor in various transversely spaced rows of filled dough; and
simultaneously crimping and cutting each of the rows of filled dough by the crimping element.

8. The method of claim 1, wherein crimping and cutting the dough creates individual dough products having lengths of less than 2 inches.

9. A dough crimping and cutting apparatus comprising:
a conveyor configured to direct dough in a first axial direction relative to a fixed frame;
a movable frame mounted, above the conveyor, for movement in the first axial direction relative to both the conveyor and the fixed frame;
a crimping element mounted on the movable frame for movement in a second axial towards and away from the conveyor, with the second axial direction being transverse to the first axial direction;
at least one drive unit configured to both a) oscillate the movable frame in the first axial direction relative to the fixed frame and b) cyclically shift the crimping element in the second axial direction wherein, during a portion of operation, the crimping element is caused to engage the conveyor to crimp and cut the dough moving along the conveyor into at least one individual dough product while the movable frame simultaneously shifts in the first axial direction in unison with the dough on the conveyor;
a cam element mounted on one of the fixed and movable frames and connected to the at least one drive unit; and
a cam follower rotatably mounted on another of the fixed and movable frames, said cam element including a peripheral surface in engagement with the cam follower to oscillate the movable frame during operation of the at least one drive unit.

10. The dough crimping and cutting apparatus according to claim 9, wherein the at least one drive unit is mounted to the movable frame for concurrent movement in the second axial direction.

11. The dough crimping and cutting apparatus according to claim 10, wherein the cam element is rotatably supported by the movable frame and the cam follower is rotatably mounted on the fixed frame.

12. The dough crimping and cutting apparatus according to claim 9, further comprising: a spring biasing the movable frame in the second axial direction such that the cam element is in constant engagement with the cam follower.

13. The dough crimping and cutting apparatus according to claim 9, wherein the cam element includes a peripheral surface establishing a cam profile configured to oscillate the movable frame while providing a dwell time during which the crimping element stays in engagement with the conveyor and the movable frame shifts in unison with the conveyor.

14. The dough crimping and cutting apparatus according to claim 13, wherein the profile includes a constant radius of curvature section over a substantial portion of the peripheral surface, with the constant radius of curvature section establishing the dwell time.

15. The dough crimping and cutting apparatus according to claim 9, further comprising: a crank shaft mounted on the movable frame and rotatably, drivingly connected to the at least one drive unit, with the crank shaft being configured to drive the crimping element for linear movement in the second axial direction upon operation of the at least one drive unit.

16. The dough crimping and cutting apparatus according to claim 9, further comprising: a series of extruder nozzles configured to extrude the dough onto the conveyor in various transversely spaced rows.

17. The dough crimping and cutting apparatus according to claim 16, wherein the dough constitutes dough with an inner filling.

18. The dough crimping and cutting apparatus according to claim 17, wherein the individual dough products constitute crimped and cut dough products having lengths of less than 2 inches.

19. The dough crimping and cutting apparatus according to claim 9, wherein the fixed frame, movable frame, at least one drive unit, crimping element, cam element and cam follower collectively form part of a modular assembly which is mounted above the conveyor as a unit.
